(19) United States
(12) Patent Application Publication
(10) Pub. No.: US 2024/0049058 A1
(43) Pub. Date: Feb. 8, 2024

(54) WIRELESS COMMUNICATION MANAGEMENT APPARATUS, WIRELESS COMMUNICATION MANAGEMENT METHOD, AND WIRELESS COMMUNICATION MANAGEMENT PROGRAM

(71) Applicant: NIPPON TELEGRAPH AND TELEPHONE CORPORATION, Tokyo (JP)

(72) Inventors: Shoko SHINOHARA, Musashino-shi (JP); Yasuhiko INOUE, Musashino-shi (JP); Yusuke ASAI, Musashino-shi (JP); Yasushi TAKATORI, Musashino-shi (JP)

(73) Assignee: NIPPON TELEGRAPH AND TELEPHONE CORPORATION, Tokyo (JP)

(21) Appl. No.: 18/269,041

(22) PCT Filed: Dec. 25, 2020
(86) PCT No.: PCT/JP2020/048623

§ 371 Date: Jun. 22, 2023

(51) Int. Cl. H04W 28/18; H04L 5/00

(52) U.S. Cl. CPC H04W 28/18; H04L 5/0048

(57) ABSTRACT

Provided is a wireless communication management apparatus that performs optimal control in units of base stations.

A wireless communication management apparatus (100) includes an acquisition unit (1131), a determination unit (1132, 1133), and a notification unit (115). The acquisition unit (1131) acquires wireless environment information related to a terminal (300) connected to a base station (200). The determination unit (1132, 1133) determines a control value that satisfies a throughput for transmitting data from the terminal (300) to the base station (200) based on the acquired wireless environment information. The notification unit (115) notifies the terminal (300) of the determined control value.

### TECHNICAL FIELD

An embodiment relates to a wireless communication management apparatus, a wireless communication management method, and a wireless communication management program.

### BACKGROUND ART

A wireless communication system including a base station and a terminal is known.

A typical example of a wireless communication system is a wireless local area network (LAN) for public use. As a wireless LAN for public use, for example, a use case in which data is transmitted from a base station to a public computer terminal and a smartphone terminal is assumed.

On the other hand, in recent years, a wireless LAN for industrial use has appeared. As a wireless LAN for industrial use, for example, a use case in which data measured by an Internet of things (IoT) terminal is transmitted to a base station is assumed.

### CITATION LIST

### Non Patent Literature

Non Patent Literature 1: ARIB STD-T108 1.3, “920 MHz-Band Telemeter, Telecontrol and Data Transmission Radio Equipment and Standards”, Apr. 12, 2019
Non Patent Literature 2: IEEE Std 802.11ah TM-2016 (IEEE Standard for Information technology—Telecommunications and information exchange between systems Local and metropolitan area networks—Specific requirements, Part 11: Wireless LAN Medium Access Control (MAC) and Physical Layer (PHY) Specifications, Amendment 2: Sub 1 GHz License Exempt Operation, IEEE Computer Society, 7 Dec. 2016

### SUMMARY OF INVENTION

### Technical Problem

In a use case of a wireless LAN for public use, data transmission (downlink traffic) from a base station to an unspecified number of terminals is assumed to be the main communication. Therefore, in a case of managing a wireless LAN for public use, various control parameters are set mainly based on a wireless environment related to downlink traffic.

On the other hand, in a use case of a wireless LAN for industrial use, data transmission (uplink traffic) from a specific large number of terminals to a base station is assumed to be the main communication. For this reason, in a case where the management method of the wireless environment of a wireless LAN for public use is applied to a wireless LAN for industrial use, there is a possibility that control parameters cannot be optimized and sufficient throughput cannot be obtained.

The present invention has been made in view of the above circumstances, and an object thereof is to provide wireless communication management means for performing optimal control in units of base stations in a wireless communication system in which upstream traffic is assumed to be the main communication.

### Solution to Problem

In order to solve the above problem, a first aspect of the present invention is a wireless communication management apparatus including: an acquisition unit that acquires wireless environment information related to a terminal connected to a base station; a determination unit that determines a control value that satisfies a throughput for transmitting data from the terminal to the base station based on the wireless environment information; and a notification unit that notifies the terminal of the control value.

### Advantageous Effects of Invention

According to the first aspect of the present invention, it is possible to provide wireless communication management means that performs optimal control in units of base stations in a wireless communication system in which upstream traffic is assumed to be the main communication.

### BRIEF DESCRIPTION OF DRAWINGS

FIG. 1 is a schematic diagram for comparing sequence times when RTS/CTS is not used and when RTS/CTS is used.

FIG. 2 is a schematic diagram for comparing loss times when RTS/CTS is not used and when RTS/CTS is used.

FIG. 3 is a block diagram illustrating an example of a configuration of a communication system according to an embodiment.

FIG. 4 is a block diagram illustrating an example of a hardware configuration of a wireless communication management apparatus according to the embodiment.

FIG. 5 is a block diagram illustrating an example of a hardware configuration of a base station according to the embodiment.

FIG. 6 is a block diagram illustrating an example of a hardware configuration of a terminal according to the embodiment.

FIG. 7 is a block diagram illustrating an example of a functional configuration of the wireless communication management apparatus according to the embodiment.

FIG. 8 is a block diagram illustrating an example of a detailed configuration of a control information generation unit of the wireless communication management apparatus illustrated in FIG. 7.

FIG. 9 is a block diagram illustrating an example of a functional configuration of the base station according to the embodiment.

FIG. 10 is a block diagram illustrating an example of a functional configuration of the terminal according to the embodiment.

FIG. 11 is a flowchart illustrating an example of a control value determination operation in the wireless communication management apparatus according to the embodiment.

FIG. 12 is a schematic diagram illustrating an example of a reference table used in the control value determination operation.

FIG. 13 is a diagram illustrating a simulation result of control value determination by the wireless communication management apparatus according to the embodiment.

FIG. 14 is a block diagram illustrating an example of a configuration of a communication system according to a modification of the embodiment.

FIG. 15 is a block diagram illustrating an example of a functional configuration of a relay base station according to the modification of the embodiment.

### DESCRIPTION OF EMBODIMENTS

Hereinafter, an embodiment will be described with reference to the drawings. Note that in the following description, components having the same function and configuration are denoted by the same reference numerals. In addition, when distinguishing among a plurality of components having a common reference sign, the component is distinguished by an additional reference sign (e.g., hyphen and number such as “−1”) attached after the common reference sign.

### 1. Embodiment

1.1 Overview

In a wireless LAN in which a base station and a terminal operate in an autonomously distributed manner, carrier sense multiple access with collision avoidance (CSMA/CA) can be adopted as an access control method for avoiding collision. In CSMA/CA, a terminal that intends to transmit a data frame first checks the usage status of a channel (frequency band) used by carrier sensing. If the channel is unused, the terminal starts transmission after waiting for a random time period. If the channel is in use, the terminal waits for a certain time period and then attempts transmission again. In this way, each terminal autonomously determines the transmission timing of a data frame in order to avoid collision.

Here, in the use case of a wireless LAN for industrial use described above, a large number of terminals are connected to the base station, and a large amount of uplink traffic is generated. Therefore, the number of collisions of frames increases, leading to a decrease in throughput.

Request to send/clear to send (RTS/CTS) can be used to minimize the impact of frame collision. RTS/CTS is a frame for causing each terminal to acquire a transmission right prior to data transmission. First, a transmission-side terminal transmits an RTS frame to a destination base station. When receiving the RTS frame normally, the destination base station returns a CTS frame to the terminal as a response. When receiving the CTS frame, the terminal acquires a transmission right, and sends a data frame to the base station. By using RTS/CTS, while a time loss at the time of occurrence of a collision can be curbed, a sequence time corresponding to a time (e.g., standby time, transmission request time, response time, data frame transmission time, inter-frame time, and response time) involved in transmission of a data frame increases, resulting in a decrease in throughput (i.e., longer sequence length causes decrease in throughput).

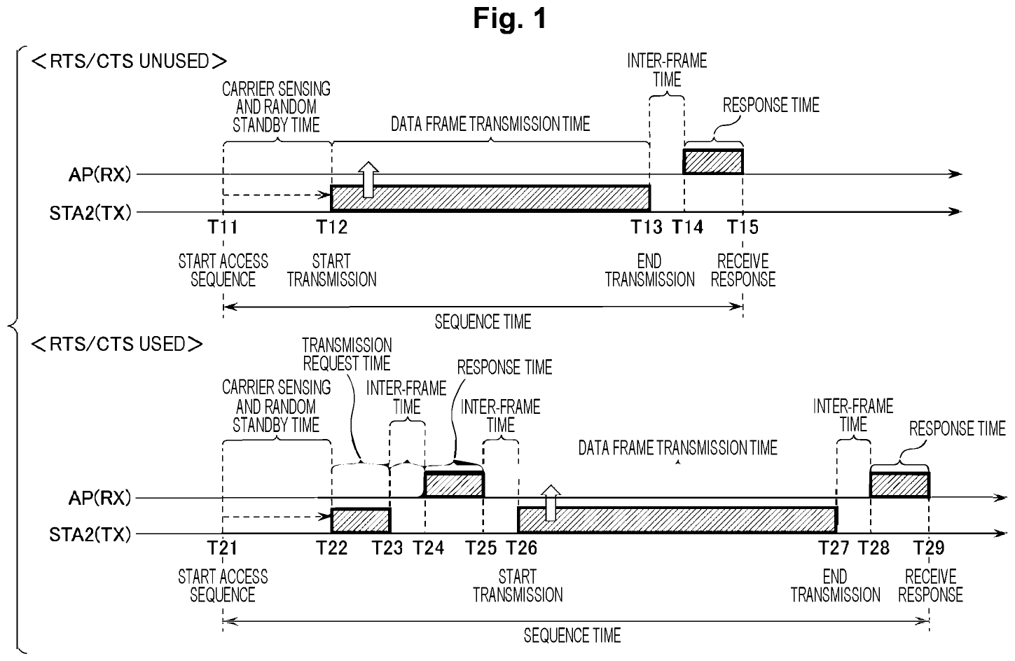

FIG. 1 illustrates a comparison between sequence times in a case where RTS/CTS is not used and in a case where RTS/CTS is used.

The upper side of FIG. 1 illustrates an example of a sequence time at which a terminal STA2 (transmission side (TX)) transmits a data frame to a base station AP (reception side (RX)) in a case where RTS/CTS is not used. At T11, an access sequence is started, and the terminal STA2 performs carrier sensing. If the channel is unused, the terminal STA2 starts transmission of a data frame at T12 after passage of a further random standby time to avoid collision. At T13, terminal STA2 ends the transmission of the data frame. The base station AP returns a response indicating that the data is received normally at T14 after passage of an inter-frame time since reception of the data frame. At T15, the terminal STA2 receives the response. In this example, the sequence time corresponds to a period from T11 to T15.

The lower side of FIG. 1 illustrates an example of a sequence time at which the terminal STA2 (transmission side (TX)) transmits a data frame to the base station AP (reception side (RX)) in a case where RTS/CTS is used. At T21, an access sequence is started, and the terminal STA2 performs carrier sensing. If the channel is unused, the terminal STA2 transmits a short request to send (RTS) frame at T22 after passage of a further random standby time to avoid collision. At T23, the terminal STA2 ends the transmission of the RTS frame. The base station AP responds to the terminal STA2 by starting transmission of a CTS frame at T24 after passage of an inter-frame time since reception of the RTS. When the terminal STA2 receives the CTS frame at T25, the terminal STA2 further starts transmission of a data frame at T26 after passage of the inter-frame time. At T27, terminal STA2 ends the transmission of the data frame. The base station AP returns a response indicating that the data is received normally at T28 after passage of the inter-frame time since reception of the data frame. At T29, the terminal STA2 receives the response. In this example, the sequence time corresponds to a period from T21 to T29.

As illustrated in FIG. 1, when RTS/CTS is used, the sequence time becomes longer by the time from T22 to T26 in which RTS/CTS is performed than when RTS/CTS is not used.

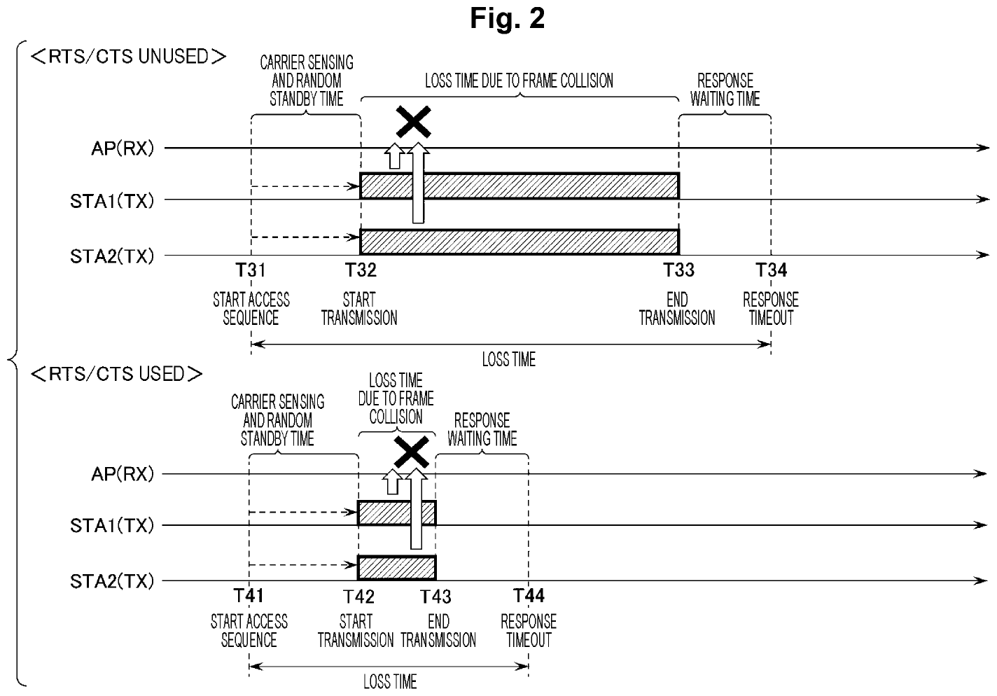

FIG. 2 illustrates a comparison of loss times at the time of occurrence of a frame collision between a case where RTS/CTS is not used and a case where RTS/CTS is used.

The upper side of FIG. 2 illustrates an example of a loss time when a terminal STA1 and the terminal STA2 simultaneously attempt to transmit a data frame to the base station AP and a collision occurs in a case where RTS/CTS is not used. Similar to FIG. 1, an access sequence is started at T31, and the terminal STA2 performs carrier sensing and starts transmission of a data frame at T32 after passage of a random standby time. However, in this example, the transmission timing accidentally overlaps with that of another terminal STA1, and a frame collision occurs. After completion of the transmission at T33, the terminal STA2 waits for a response from the base station AP for a response waiting time. Since the base station AP does not receive the frame normally due to the collision, the base station AP does not return a response. When a timeout occurs at T34, the terminal STA2 attempts retransmission of the data frame. In this example, the loss time corresponds to a period from T31 to T34.

The lower side of FIG. 2 illustrates an example of a loss time when the terminal STA2 transmits an RTS frame, the terminal STA1 attempts to transmit a frame to base station AP at the same time, and a collision occurs in a case where RTS/CTS is used. Similar to FIG. 1, an access sequence is started at T41, and the terminal STA2 performs carrier sensing and starts transmission of an RTS frame at T42 after a random standby time. However, in this example, the transmission timing accidentally overlaps with that of another terminal STA1, and a frame collision occurs. After completion of the transmission at T43, the terminal STA2 waits for a response from the base station AP for a response waiting time. Since the base station AP does not receive the frame normally due to the collision, the base station AP does not return a response. When a timeout occurs at T44, the terminal STA2 attempts retransmission of the RTS frame. In this example, the loss time corresponds to a period from T41 to T44.

As illustrated in FIG. 2, it can be seen that the loss time is shortened by the difference between the length of the data frame and the length of the RTS frame when RTS/CTS is used as compared with when RTS/CTS is not used.

Further, a sequence of adjusting CSMA/CA random standby time can also be used to reduce the probability of collision. The random standby time is adjusted by adjusting the size of a contention window (CW). CW specifies a random number generation range. The terminal performs carrier sensing after a random standby time based on a random number value generated from the range of [0, CW]. A terminal having a shorter standby time is given a higher priority. As the CW is increased, the random number generation range is widened, and the possibility of collision can be reduced. However, in a case where the possibility of collision is originally low, the sequence time becomes long, which causes a decrease in throughput.

While the base station can grasp the possibility of collision in the entire area, the terminal cannot grasp the possibility of collision and change the parameter as described above, and there is no means for simultaneously controlling the terminals.

In the embodiment, a base station or a calculation resource connected to the base station acquires wireless environment information (e.g., number of connected terminals, traffic amount, and the like) related to a terminal connected to each base station, and determines a control value that satisfies the throughput for transmitting data from the terminal to the base station. The control value can also be referred to as a control parameter (e.g., parameter related to RTS/CTS or CW). Each terminal is notified of the determined control value, and each terminal uses the control value for parameter setting. As a result, the sequence is determined for each base station according to the wireless environment information.

1.2 Configuration

1.2.1 Overall Configuration

First, a configuration of the communication system according to the embodiment will be described.

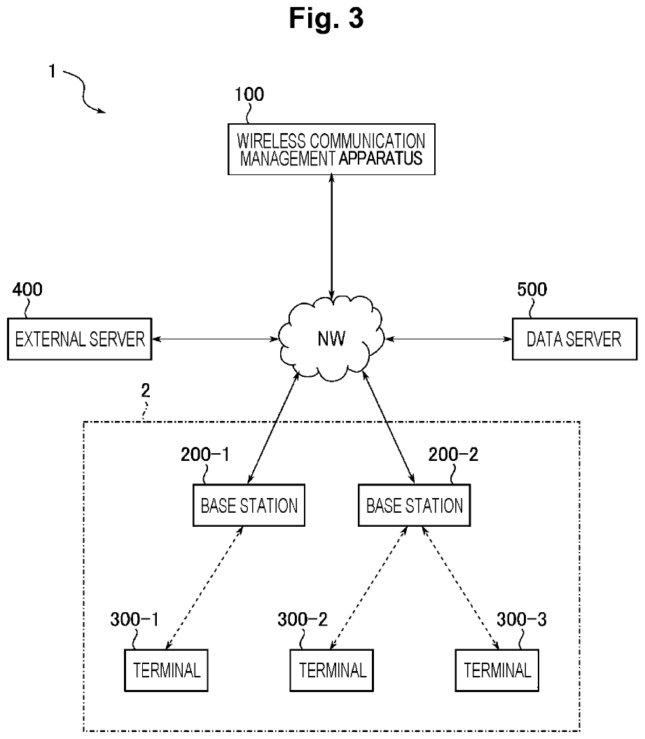

FIG. 3 is a block diagram illustrating an example of a configuration of the communication system according to the embodiment.

As illustrated in FIG. 3, a communication system 1 is a system that manages a wireless environment of a wireless communication system 2. The communication system 1 includes a wireless communication management apparatus 100, a plurality of base stations 200-1 and 200-2, a plurality of terminals 300-1, 300-2, and 300-3, an external server 400, and a data server 500. The plurality of base stations 200-1 and 200-2 and the plurality of terminals 300-1 to 300-3 form the wireless communication system 2.

Hereinafter, each of the plurality of base stations 200-1 and 200-2 may be referred to as “base station 200” unless otherwise distinguished. Each of the plurality of terminals 300-1 to 300-3 may be referred to as “terminal 300” unless otherwise distinguished. Furthermore, the base station 200 and the terminal 300 may be collectively referred to as “device”.

The wireless communication system 2 is a wireless communication system for industrial use. The wireless communication system 2 is configured to use a frequency band (unlicensed band) that can be used without a wireless station license. In the wireless communication system 2, for example, a sub-GHz band is used as an unlicensed band. The sub-GHz band includes, for example, the 920 MHz band.

The wireless communication management apparatus 100 is an on-premises data processing server for managing a wireless environment of the wireless communication system 2. The wireless communication management apparatus 100 is configured to establish wired connection with the base station 200, the external server 400, and the data server 500 via, for example, a router or a hub (not illustrated) in a network NW.

The base station 200 is a master unit (AP: access point) of the wireless communication system 2. The base station 200 is configured to connect the terminal 300 and the wireless communication management apparatus 100 and connect the terminal 300 and the data server 500 via the network NW.

The terminal 300 is a slave unit (STA: station) of the wireless communication system 2. The terminal 300 is, for example, an IoT terminal. The terminal 300 is configured to wirelessly connect to a corresponding base station 200.

In the example of FIG. 3, the terminal 300-1 is configured to wirelessly connect to the base station 200-1. The terminals 300-2 and 300-3 are configured to wirelessly connect to the base station 200-2. However, the terminal 300-1 may also be configured to wirelessly connect to the base station 200-2. The terminals 300-2 and 300-3 may also be configured to wirelessly connect to the base station 200-1. In this manner, the wireless connection between the terminal 300 and the base station 200 may be appropriately selected from a plurality of paths.

The external server 400 is, for example, a server that stores information (external environment information) regarding the external environment of the wireless communication system 2.

The data server 500 is, for example, a server in which sensor information measured by the wireless communication system 2 is aggregated and stored.

1.2.2 Hardware Configuration

Next, a hardware configuration of a main configuration in the communication system according to the embodiment will be described.

(Wireless Communication Management Apparatus)

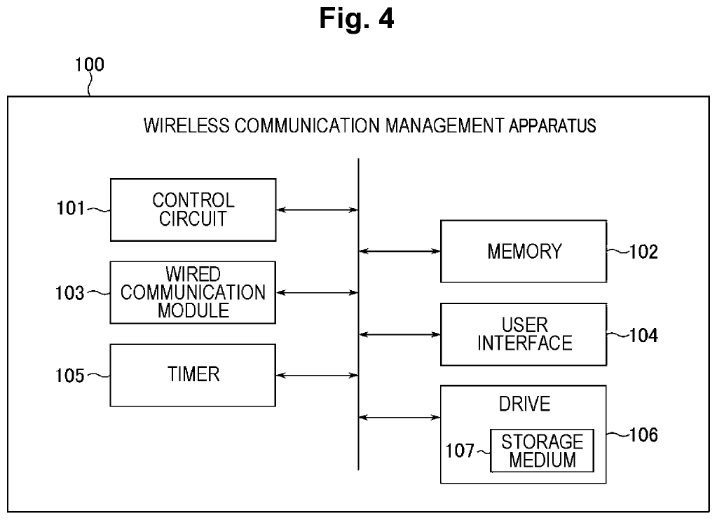

FIG. 4 is a block diagram illustrating an example of a hardware configuration of the wireless communication management apparatus according to the embodiment.

The wireless communication management apparatus 100 includes a control circuit 101, a memory 102, a wired communication module 103, a user interface 104, a timer 105, and a drive 106.

The control circuit 101 is a circuit that has overall control of the components of the wireless communication management apparatus 100. The control circuit 101 includes a central processing unit (CPU), a random access memory (RAM), a read only memory (ROM), and the like.

The memory 102 is an auxiliary storage apparatus of the wireless communication management apparatus 100. The memory 102 includes, for example, a hard disk drive (HDD), a solid state drive (SSD), a memory card, and the like. The memory 102 stores various types of information used for a wireless communication management operation and a wireless communication management program. The wireless communication management program can be stored in the memory 102 by being transmitted from outside the wireless communication management apparatus 100 via the network NW.

The wireless communication management operation is a series of operations performed to appropriately manage a wireless communication environment in the wireless communication system 2. The wireless communication management program is a program for causing the control circuit 101 to perform the wireless communication management operation. Details regarding the wireless communication management operation will be described later.

The wired communication module 103 is a circuit used for transmission and reception of data by a wired signal. The wired communication module 103 is configured, for example, to conform to the TCP/IP hierarchical model. Specifically, for example, a configuration of the wired communication module 103 corresponding to the network interface layer is compliant with Ethernet. A configuration of the wired communication module 103 corresponding to the Internet layer is compliant with the Internet protocol (IP). A configuration of the wired communication module 103 corresponding to the transport layer is compliant with the transmission control protocol (TCP). A configuration of the wired communication module 103 corresponding to the application layer is compliant with the Secure shell (SSH).

The user interface 104 is a circuit for communicating information between the user and the control circuit 101. The user interface 104 includes an input apparatus and a display apparatus. The input apparatus includes, for example, a touch panel, an operation button, and the like. The display apparatus includes, for example, a liquid crystal display (LCD), an electroluminescence (EL) display, and the like. The user interface 104 converts an input (user input) from the user into an electrical signal, and then transmits the electrical signal to the control circuit 101.

The timer 105 is a circuit that measures time. For example, the timer 105 starts counting based on a start instruction from the control circuit 101 (set). When the count value becomes equal to or larger than a threshold in the set state, the timer 105 notifies the control circuit 101 of a timeout (timeout). The timer 105 ends counting based on an end instruction from the control circuit 101 (reset).

The drive 106 is a device for reading a program stored in a storage medium 107. The drive 106 includes, for example, a compact disk (CD) drive, a digital versatile disk (DVD) drive, and the like.

The storage medium 107 is a medium that accumulates information such as programs by electrical, magnetic, optical, mechanical, or chemical action. The storage medium 107 may store the wireless communication management program.

(Base Station)

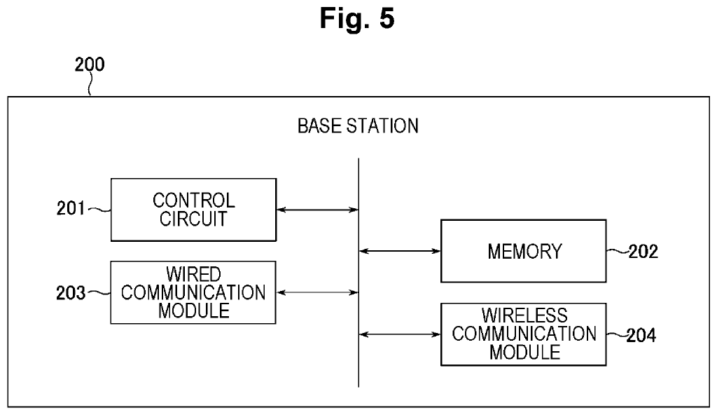

FIG. 5 is a block diagram illustrating an example of a hardware configuration of the base station according to the embodiment.

As illustrated in FIG. 5, the base station 200 includes a control circuit 201, a memory 202, a wired communication module 203, and a wireless communication module 204.

The control circuit 201 is a circuit that has overall control of the component of the base station 200. The control circuit 201 includes a CPU, a RAM, a ROM, and the like.

The memory 202 is an auxiliary storage device of the base station 200. The memory 202 includes, for example, an HDD, an SSD, a memory card, and the like. The memory 202 stores control information of the base station 200 generated by the wireless communication management apparatus 100 in the wireless communication management operation.

The wired communication module 203 is a circuit used for transmission and reception of data by a wired signal. The wired communication module 203 conforms to a protocol stack equivalent to that of the wired communication module 103. With this configuration, the wired communication module 203 can be connected to the wired communication module 103 by wire.

The wireless communication module 204 is a circuit used for transmission and reception of data by a wireless signal. The wireless communication module 204 is connected to an antenna (not illustrated). The wireless communication module 204 is configured, for example, to conform to the TCP/IP hierarchical model. Specifically, for example, a configuration of the wireless communication module 204 corresponding to the network interface layer is compliant with Institute of electrical and electronics engineers (IEEE) 802.11 ah. A configuration of the wireless communication module 204 corresponding to the Internet layer is compliant with the IP. A configuration of the wireless communication module 204 corresponding to the transport layer is compliant with the TCP. A configuration of the wireless communication module 204 corresponding to the application layer is compliant with the SSH.

(Terminal)

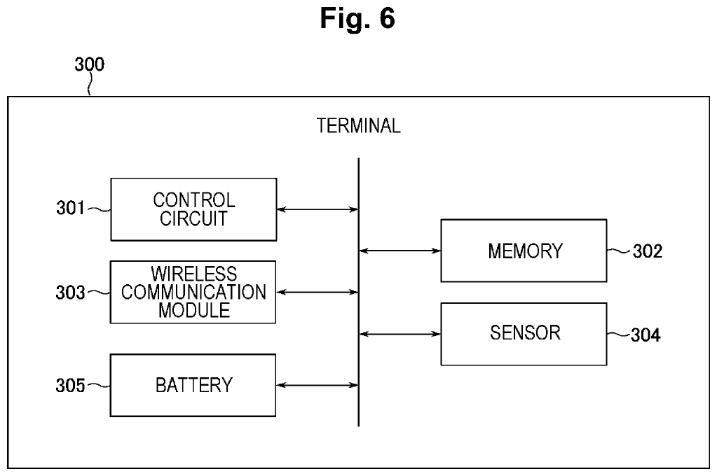

FIG. 6 is a block diagram illustrating an example of a hardware configuration of the terminal according to the embodiment.

As illustrated in FIG. 6, the terminal 300 includes a control circuit 301, a memory 302, a wireless communication module 303, a sensor 304, and a battery 305.

The control circuit 301 is a circuit that has overall control of the components of the terminal 300. The control circuit 301 includes a CPU, a RAM, a ROM, and the like.

The memory 302 is an auxiliary storage device of the terminal 300. The memory 302 includes, for example, an HDD, an SSD, a memory card, and the like. The memory 302 stores control information generated by the wireless communication management apparatus 100 in the wireless communication management operation and sensor information measured by the sensor 304.

The wireless communication module 303 is a circuit used for transmission and reception of data by a wireless signal. The wireless communication module 303 conforms to a protocol stack equivalent to that of the wireless communication module 204. With this configuration, the wireless communication module 303 can be wirelessly connected to the wireless communication module 204.

The sensor 304 is a circuit that measures data monitored by the wireless communication system 2. Sensor information measured by the sensor 304 is aggregated in the data server 500 via the base station 200 and the network NW.

The battery 305 is a capacity for supplying power to the terminal 300. The battery 305 is charged by, for example, a solar power generation module (not illustrated). The terminal 300 may be stably supplied with power from a commercial power supply.

1.2.3 Functional Configuration

Next, a functional configuration of a main configuration in the communication system of the embodiment will be described.

(Wireless Communication Management Apparatus)

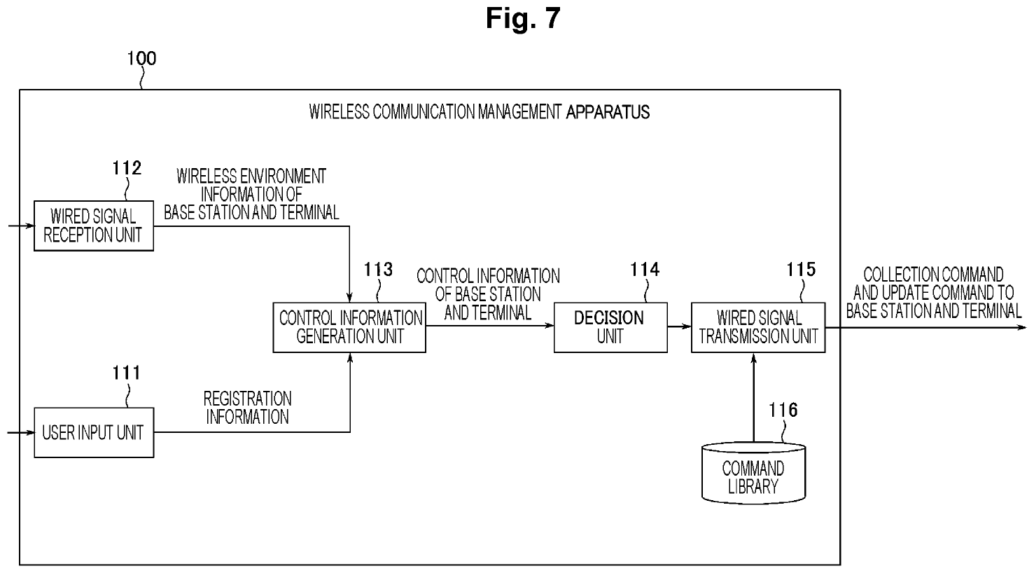

FIG. 7 is a block diagram illustrating an example of a functional configuration of the wireless communication management apparatus according to the embodiment.

The CPU of the control circuit 101 loads the wireless communication management program stored in the memory 102 or the storage medium 107 into the RAM. Then, the CPU of the control circuit 101 controls each of the components 102 to 106 by interpreting and executing the wireless communication management program expanded in the RAM. As a result, as illustrated in FIG. 7, the wireless communication management apparatus 100 functions as a computer including a user input unit 111, a wired signal reception unit 112, a control information generation unit 113, a decision unit 114, a wired signal transmission unit 115, and a command library 116.

The user input unit 111 transmits registration information input by the user to the control information generation unit 113. The registration information includes designation information, device information, and constraint information.

Designation information is information for designating a decision condition for determining the control value. Designation information includes a threshold, a reference table, and the like, and is arbitrarily set by a user (system administrator or the like). The threshold may be used to compare to a value of wireless environment information, for example, as a threshold for selecting use/non-use of a particular sequence. The reference table associates, for example, a value of wireless environment information with a value of a control parameter, and can be used to determine the value of a control parameter according to wireless environment information.

Device information is information for the wireless communication management apparatus 100 to uniquely identify the base station 200 and the terminal 300. Device information includes, for example, a username, a password, an IP address, a management target flag, and the like for each of the base station 200 and the terminal 300. A username, a password, and an IP address are used for the wireless communication management apparatus 100 to remotely log in to the base station 200 and the terminal 300 using a protocol such as SSH. The management target flag is information for identifying whether or not the corresponding base station 200 and terminal 300 are targets of the wireless communication management operation.

Constraint information is information indicating constraint conditions to be complied with by the wireless communication system 2 based on laws such as the Radio law. Constraint information includes, for example, an upper limit value of the total transmission time for each device.

The wired signal reception unit 112 receives wireless environment information regarding the base station 200 and the terminal 300 from the base station 200. The wired signal reception unit 112 may also receive external environment information (e.g., information necessary to evaluate throughput of wireless communication) from the external server 400. The wired signal reception unit 112 transmits the received pieces of environment information to the control information generation unit 113.

Wireless environment information is information collected from the base station 200 and the terminal 300 to perform the wireless communication management operation. Wireless environment information is collected to reflect the latest wireless environment periodically or in response to user instructions. Wireless environment information includes the number of terminals 300 connected to each base station 200 or the amount of traffic transmitted and received per unit time by the terminals 300 connected to each base station 200. Furthermore, wireless environment information can include, for example, an SSID, a channel, a bandwidth, a frequency, a received signal strength indication (RSSI), and the like of a peripheral basic service set (BSS) as information common to the base station 200 and the terminal 300. Wireless environment information can include, for example, information indicating the remaining capacity of the battery 305 as information specific to the terminal 300.

External environment information is information collected from the external server 400 to evaluate the throughput of wireless communication. External environment information includes, for example, a predicted value of sunshine hours in an area where the wireless communication system 2 is provided. The collection of external environment information may be omitted in this embodiment.

The control information generation unit 113 can function as an acquisition unit that acquires wireless environment information regarding a terminal connected to the base station 200 and a determination unit that determines a control value that satisfies the throughput for transmitting data from the terminal to the base station based on the wireless environment information. Here, the “terminal connected to the base station” refers to any terminal device that is directly or indirectly connected to the base station and communicates with the data server 500 via the base station. In the embodiment, the control information generation unit 113 receives registration information from the user input unit 111 and wireless environment information from the wired signal reception unit 112, and extracts information necessary for the subsequent operation. Then, the control information generation unit 113 determines an optimal control value for each base station and generates control information of the base station 200 and the terminal 300. The control information generation unit 113 may store the received pieces of information in the memory 102 until all the information used for the wireless communication management operation is prepared. The control information generation unit 113 transmits the generated control information to the decision unit 114.

Control information is a parameter used for constructing a wireless communication environment of the base station 200 and the terminal 300. In the embodiment, control information includes parameters related to data transmission from the terminal 300 to the base station 200. An example of such a parameter is a parameter related to necessity of transmission of an RTS frame from the terminal 300 to the base station 200 or a parameter related to calculation of a standby time in the terminal 300. In other words, the control information generation unit 113 selects an optimal sequence for each base station by determining an optimal parameter that satisfies the throughput for each base station.

The decision unit 114 decides whether or not to update the setting of the wireless environment by the generated control information for each of the base station 200 and the terminal 300 for which the control information has been generated. In addition, the decision unit 114 further decides, for each of the base station 200 and the terminal 300 decided to update the setting of the wireless environment, whether or not the update involves a restart. The decision unit 114 outputs a set of control information and a decision result for each of the base station 200 and the terminal 300 to the wired signal transmission unit 115.

The wired signal transmission unit 115 generates various commands for controlling the base station 200 and the terminal 300 based on an instruction from the control circuit 101. The various commands are generated with reference to the command library 116.

In the command library 116, a command group used for the wireless communication management operation is stored in advance. The command library 116 stores, for example, a collection command and an update command. The collection command is a command for collecting wireless environment information from the designated base station 200 or terminal 300 (designated by IP address or the like). The update command is a command for updating the setting of the wireless environment of the designated base station 200 or terminal 300 (designated by IP address or the like) with the control information. Therefore, the update command includes control information for updating the setting of the wireless environment of the designated base station 200 or terminal 300. In addition, the update command may include an instruction to restart the designated base station 200 or terminal 300.

The wired signal transmission unit 115 functions as a notification unit that notifies the terminal 300 of a determined control value.

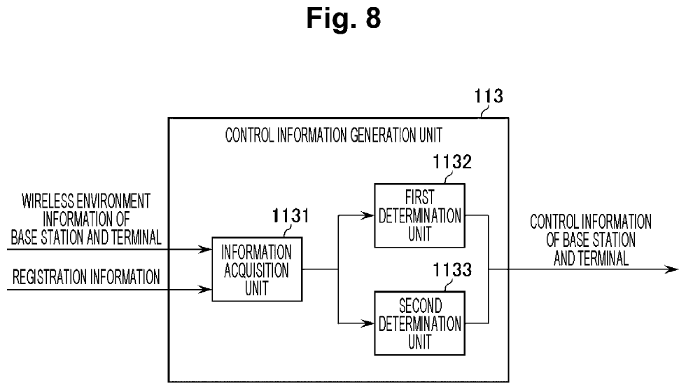

FIG. 8 is a block diagram illustrating an example of a detailed configuration of the control information generation unit 113 according to the embodiment. The control information generation unit 113 can include an information acquisition unit 1131, a first determination unit 1132, and a second determination unit 1133.

The information acquisition unit 1131 performs processing of receiving wireless environment information of the base station 200 and the terminal 300 and registration information, extracting necessary information, and passing the information to the first determination unit 1132 or the second determination unit 1133. For example, the information acquisition unit 1131 acquires the number of terminals 300 connected to the base station 200 (hereinafter, “number of connected terminals”) based on the wireless environment information, and passes the acquired number to the first determination unit 1132 and the second determination unit 1133. Alternatively, for example, the information acquisition unit 1131 acquires a traffic amount transmitted and received per unit time by the terminal 300 connected to the base station 200, and passes the traffic amount to the first determination unit 1132 and the second determination unit 1133. The information acquisition unit 1131 can be further configured to read a preset threshold included as designation information in the registration information and pass the threshold to the first determination unit 1132. The information acquisition unit 1131 can be further configured to read a preset reference table included as designation information in the registration information and pass the reference table to the second determination unit 1133.

The first determination unit 1132 determines a first parameter related to necessity of transmission of a transmission request frame from the terminal 300 to the base station 200 based on the information received from the information acquisition unit 1131. An example of the first parameter is RTS_threshold (RTS threshold). RTS_threshold is a threshold for determining whether each terminal 300 sends an RTS frame before data transmission. In other words, the first determination unit 1132 selects ON/OFF of the RTS/CTS procedure by determining RTS_threshold for each base station 200. For example, based on the number of connected terminals received from the information acquisition unit 1131 and a threshold, when the number of connected terminals exceeds the threshold, the first determination unit 1132 selects ON of RTS/CTS for the base station 200. The operation of the first determination unit 1132 will be further described later.

The second determination unit 1133 determines a second parameter related to calculation of a standby time in the terminal 300 based on the information received from the information acquisition unit 1131. An example of the second parameter is CWmin. CWmin is a parameter that specifies the minimum value of the upper limit value of CW and relates to the initial random number generation range. For example, the second determination unit 1133 selects the value of CWmin based on the number of connected terminals received from the information acquisition unit 1131 and the reference table. The operation of the second determination unit 1133 will also be described later. Note that CWmin≤CW is satisfied.

(Base Station)

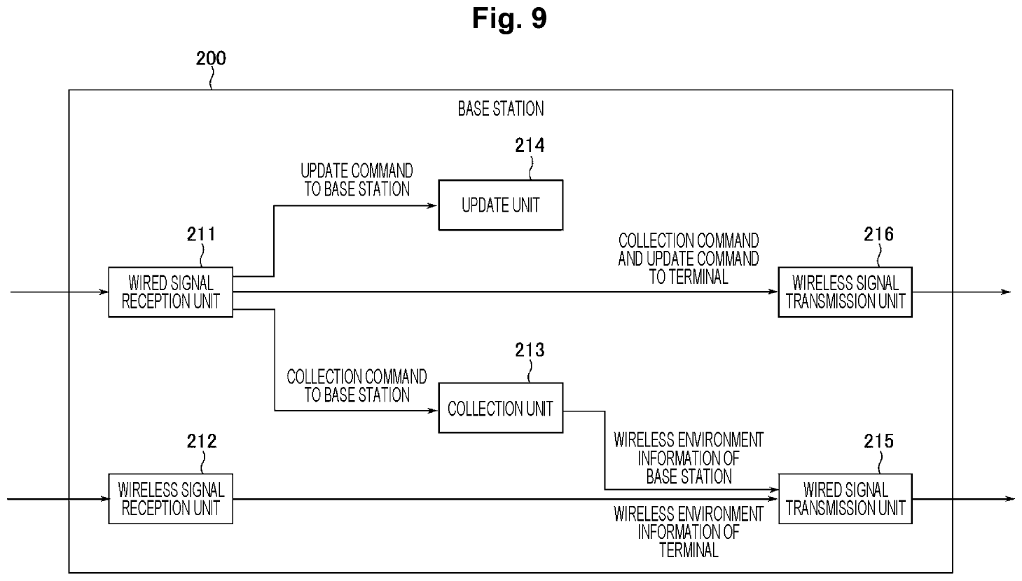

FIG. 9 is a block diagram illustrating an example of a functional configuration of the base station according to the embodiment.

The CPU of the control circuit 201 controls each of the components 202 to 204 based on various commands transmitted from the wireless communication management apparatus 100. As a result, as illustrated in FIG. 9, the base station 200 functions as a computer including a wired signal reception unit 211, a wireless signal reception unit 212, a collection unit 213, an update unit 214, a wired signal transmission unit 215, and a wireless signal transmission unit 216.

The wired signal reception unit 211 receives a collection command and an update command from the wireless communication management apparatus 100. When receiving a collection command (to base station 200) addressed to the base station 200, the wired signal reception unit 211 transmits the collection command to the collection unit 213. When receiving an update command to the base station 200, the wired signal reception unit 211 transmits the update command to the update unit 214. When receiving a collection command and an update command (to terminal 300) addressed to the terminal 300, the wired signal reception unit 211 transmits the collection command and the update command to the wireless signal transmission unit 216. When data is transmitted from the wired signal reception unit 211 to the wireless signal transmission unit 216, the transmission data is converted from the Ethernet frame format to the 802.11 ah frame format.

The wireless signal reception unit 212 receives wireless environment information of the terminal 300 from the terminal 300. The wireless signal reception unit 212 transmits the received wireless environment information of the terminal 300 to the wired signal transmission unit 215. When data is transmitted from the wireless signal reception unit 212 to the wired signal transmission unit 215, the transmission data is converted from the 802.11 ah frame format to the Ethernet frame format.

The collection unit 213 collects wireless environment information of the base station 200 based on the received collection command. The collection unit 213 transmits the collected wireless environment information of the base station 200 to the wired signal transmission unit 215.

The update unit 214 updates the setting of the wireless environment of the base station 200 with control information in the update command based on the received update command. When the update command includes a restart instruction, the update unit 214 restarts the base station 200.

The wired signal transmission unit 215 transmits the received wireless environment information of the base station 200 to the wireless communication management apparatus 100. The wired signal transmission unit 215 transfers the received wireless environment information of the terminal 300 to the wireless communication management apparatus 100.

The wireless signal transmission unit 216 transfers the received collection command and update command of the terminal 300 to the terminal 300.

(Terminal)

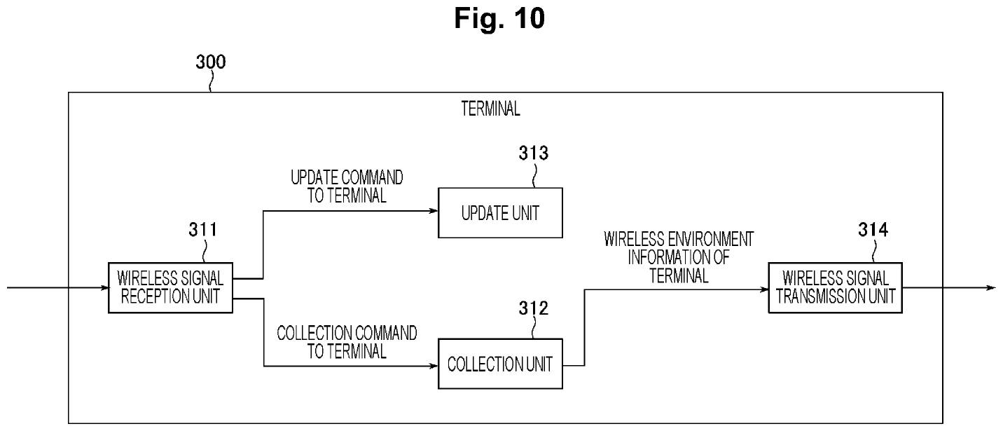

FIG. 10 is a block diagram illustrating an example of a functional configuration of the terminal according to the embodiment.

The CPU of the control circuit 301 controls each of the components 302 and 303 based on various commands transmitted from the wireless communication management apparatus 100. As a result, as illustrated in FIG. 10, the terminal 300 functions as a computer including a wireless signal reception unit 311, a collection unit 312, an update unit 313, and a wireless signal transmission unit 314.

The wireless signal reception unit 311 receives a collection command and an update command from the base station 200. The wireless signal reception unit 311 transmits the collection command to the collection unit 312. The wireless signal reception unit 311 transmits the update command to the update unit 313.

The collection unit 312 collects wireless environment information of the terminal 300 based on the received collection command. The collection unit 312 transmits the collected wireless environment information of the terminal 300 to the wireless signal transmission unit 314.

The update unit 313 updates the setting of the wireless environment of the terminal 300 with control information in the update command based on the received update command. When the update command includes a restart instruction, the update unit 313 restarts the terminal 300.

The wireless signal transmission unit 314 transmits the collected wireless environment information of the terminal 300 to the base station 200.

1.3 Operation

Next, an operation of the wireless communication management apparatus according to the embodiment will be described.

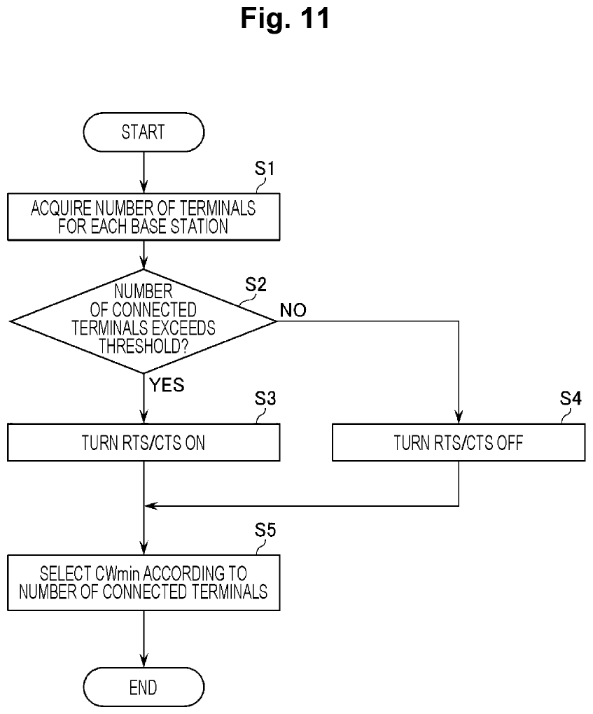

FIG. 11 is a flowchart illustrating an example of a control value determination operation in the wireless communication management operation by the wireless communication management apparatus 100 according to the embodiment. The control value determination operation is mainly performed by the control information generation unit 113.

Assume that prior to the operation of FIG. 11, the wireless communication management apparatus 100 collects registration information by the user input unit 111 and collects wireless environment information (and optionally external environment information) by the wired signal reception unit 112. The information collection operation by the wireless communication management apparatus 100 is started manually in response to an instruction from a system administrator or the like, or automatically when a predetermined time is reached. The collection of registration information and the collection of wireless environment information may be performed at different timings. The information collection operation by the wireless communication management apparatus 100 is terminated when a predetermined condition such as completion of collection from all devices or timeout of the timer 105 is satisfied. The information collected by the user input unit 111 and the wired signal reception unit 112 is passed to the control information generation unit 113. The following control value determination operation can be started with the completion of the information collection operation by the wireless communication management apparatus 100 as a trigger.

First, in step S1, the control information generation unit 113 causes the information acquisition unit 1131 to acquire the number of connected terminals for each base station 200 from the wireless environment information. The information acquisition unit 1131 also acquires information (e.g., threshold or reference table) necessary for the subsequent operation from the designation information. The information acquisition unit 1131 may acquire information from the designation information in advance, store the information in the memory 202, and read the information when necessary. The information acquisition unit 1131 passes the acquired information to the first determination unit 1132 and the second determination unit 1133.

In step S2, the control information generation unit 113 causes the first determination unit 1132 to decision whether or not the number of connected terminals exceeds a preset threshold (such as three). If the number of connected terminals exceeds the threshold (S2; YES), the first determination unit 1132 determines to turn ON (use) RTS/CTS (S3). If the number of connected terminals does not exceed the threshold (S2; NO), the first determination unit 1132 determines to turn OFF (not use) RTS/CTS (S4).

The wireless communication management apparatus 100 can achieve ON/OFF of RTS/CTS by changing a setting value of RTS_threshold. As an example, the wireless communication management apparatus 100 sets a setting value of RTS_threshold to “1500” or “1”. In this case, “RTS_threshold=1500” is intended to set “RTS/CTS: OFF”, and “RTS_threshold=1” is intended to set “RTS/CTS: ON”.

This setting is forcibly applied to all the terminals 300 connected to the base station 200. When the threshold in step S2 is three, use of RTS/CTS is determined for the base station 200 having four or more connected terminals, and non-use of RTS/CTS is determined for the base station 200 having three or less connected terminals.

In general, the larger the size of the transmitted frame, the higher the probability of collision. For example, in a conventional system, each terminal autonomously determines to use RTS/CTS when a length (byte) of a frame to be transmitted exceeds a value of the parameter RTS_threshold. Therefore, the wireless communication management apparatus 100 according to the embodiment performs substantial ON/OFF control of RTS/CTS by setting a value of RTS_threshold according to the length of a frame generally transmitted by the terminal 300 in the wireless communication system 2.

Subsequently, in step S5, the control information generation unit 113 causes the second determination unit 1133 to determine the minimum value CWmin of the size of the contention window according to the number of connected terminals. This determination is made by determining a determination pattern corresponding to the number of connected terminals in advance. Examples of the pattern include a reference table for associating the number of connected terminals with the value of CWmin, and a mathematical expression for calculating the value of CWmin based on the number of connected terminals.

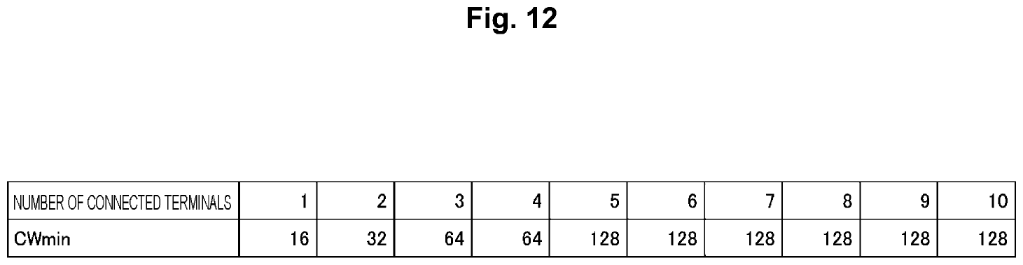

FIG. 12 illustrates an example of a reference table for determining CWmin. In the example of FIG. 12, “16” is set when the number of connected terminals is one, “32” is set when the number of connected terminals is two, and “64” is set when the number of connected terminals is three, and so on. In this example, a value of “128” is uniformly set when the number of connected terminals is five or more.

The control information generation unit 113 outputs the determination results by the first determination unit 1132 and the second determination unit 1133 to the decision unit 114 as control information. Control information includes a determined control value (control parameter). In the above example, control information includes a value (such as 1500) of the RTS_threshold parameter as the first parameter and a value (such as 128) of the CWmin parameter as the second parameter.

As described above, when receiving control information, the decision unit 114 decides the base station 200 or the terminal 300 for which the setting of the wireless environment needs to be updated. The necessity of update is decided, for example, according to whether or not the received control information is different from the control information currently set in each device. The wired signal transmission unit 115 generates a command with reference to the command library 116 and transmits the command to the device whose update is decided to be necessary. The command may include an instruction to restart the device in addition to updating of the setting. When receiving a command addressed to the base station 200 itself and a command addressed to a device that the base station 200 manages, the base station 200 updates its own setting or instructs each device to update a parameter.

Note that the operations of steps S2 to S4 by the first determination unit 1132 or the operation of step S5 by the second determination unit 1133 may be performed in a different order or may be performed in parallel. Alternatively, either the operation of the first determination unit 1132 or the operation of the second determination unit 1133 may be omitted. For example, the wireless communication management apparatus 100 may be configured to perform only determination of ON/OFF of RTS/CTS or only determination of CWmin in response to an instruction from a system administrator or the like or in response to the wireless environment information satisfying a predetermined condition.

Further, the wireless communication management apparatus 100 can determine RTS/CTS and CWmin based on the traffic amount instead of the number of connected terminals. In this case, similarly to the flow of FIG. 11, a threshold (e.g., 300 kbps, 1 Mbps, or the like) for determining the use of RTS/CTS is set in advance, and the wireless communication management apparatus 100 can determine the use (ON) of RTS/CTS when the traffic amount exceeds the threshold. In addition, similarly to the reference table of FIG. 12, a pattern for determining a correspondence between the traffic amount and CWmin is set in advance. The wireless communication management apparatus 100 can acquire the traffic amount as the sum of the uplink traffic received by each base station 200 per unit time or as the sum of the uplink traffic transmitted by each terminal 300 per unit time. The wireless communication management apparatus 100 may be configured to also consider the downstream traffic amount.

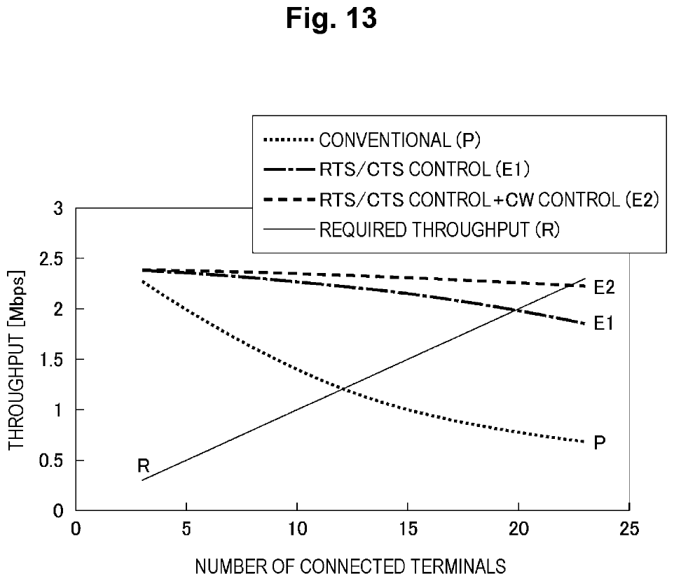

FIG. 13 is a simulation result illustrating the effect of the control value determination operation by the wireless communication management apparatus 100 according to the embodiment. The following conditions are used as evaluation conditions. Note that in order to simplify the calculation, the duty ratio is not considered, and transmission is performed as much as all the terminals can transmit.
Wireless LAN standard: IEEE 802.11ah
Data transmission modulation and coding scheme (MCS): MCS7
Bandwidth: 1 MHz
MPDU payload size:1500 byte
Aggregation:6 MPDUs
RTS/CTS transmission MCS: MCSO
Required throughput per machine: 100 kbps

As illustrated in FIG. 13, the required throughput (R) increases as the number of connected terminals increases. In the conventional method (P), as the number of connected terminals increases, the number of collisions increases, and accordingly, throughput significantly decreases.

On the other hand, in the embodiment (E1) using RTS/CTS control, it is possible to curb the decrease in throughput even when the number of connected terminals increases. Further, in the embodiment (E2) in which CW control is performed in addition to the RTS/CTS control, it is possible to further curb the decrease in throughput due to an increase in the number of connected terminals, and it is possible to substantially satisfy the required throughput even when the number of connected terminals increases.

1.4 Effects According to Embodiment

According to the embodiment, the wireless communication management apparatus 100 acquires wireless environment information related to the terminal 300 connected to each base station 200. The wireless communication management apparatus 100 determines a control value that satisfies a throughput for transmitting data from each terminal 300 to the base station 200 based on the wireless environment information. The wireless communication management apparatus 100 notifies each base station 20 of the determination result of the control value using an update command. As a result, the wireless communication management apparatus 100 can optimize the wireless environment based on the collected wireless environment information for each base station 200.

According to the embodiment, the wireless communication management apparatus 100 further uses, as the wireless environment information, the number of terminals 300 connected to each base station 200 or the traffic amount transmitted and received per unit time by the terminal 300 connected to each base station 200. The wireless communication management apparatus 100 determines, as an example of the control value, a value of a parameter (e.g., RTS_threshold) related to necessity of transmission of a transmission request frame from each terminal 300 to the base station 200 and a value of a parameter (e.g., CWmin) related to calculation of a standby time in each terminal 300 based on the wireless environment information.

As a result, in a network in which optimization of the entire area is difficult due to autonomous distributed control, the wireless communication management apparatus 100 can achieve optimization in the area, and perform control to maximize throughput while minimizing the influence of frame collision.

In a conventional wireless LAN for public use, an unspecified number of terminals can freely start connection with a wireless communication system and freely terminate the connection with the wireless communication system. Therefore, when managing wireless communication of a public wireless LAN, it is difficult for the wireless communication management apparatus to manage which terminal is connected. That is, when managing wireless communication of a public wireless LAN, it is difficult for the wireless communication management apparatus to consider the individual wireless environment of a terminal and to control the setting of the terminal.

In addition, in the conventional system, a terminal having the RTS/CTS function implemented therein determines whether or not to use RTS/CTS according to a setting (according to frame length to be transmitted or the like) or by using its own decision criterion. By using RTS/CTS, a data frame is transmitted after a communication between the transmission side and the destination side (reception preparation completion in response to a transmission request) is confirmed in a short frame, so that a loss time at the time of a collision is shortened. Note, however, that since this elongates sequence time, the throughput decreases when RTS/CTS is used even in a case where there are few collisions. While the base station can grasp the possibility of collision in the entire wireless LAN area, the terminal cannot grasp the information and determine the use of RTS/CTS, and there is no means for simultaneously controlling the terminals. Therefore, it is extremely difficult to maximize throughput while minimizing frame collision. That is, in order to maximize throughput, it is necessary to calculate the possibility of collision based on the number of connected terminals and the like and determine whether or not to use RTS/CTS.

Also, the larger the size of the contention window (CW), the lower the likelihood of frame collision. However, since this also elongates sequence time, using a large CW causes a decrease in throughput even in a case where there are few collisions. Similarly, when not all the terminals are set to the same CW, a deviation occurs among the terminals in the standby time until the access. Therefore, simultaneous control is required among the terminals connected to the base station, but there is no means for the simultaneous control in the wireless LAN for public use. Therefore, all the terminals operate at the initial values, and it is difficult to reduce the possibility of collision.

In IEEE 802.11ah, a restricted access window (RAW) function that adjusts the access timing of each terminal is defined, and there is a sequence that minimizes collision of terminals that transmit with a similar amount of traffic. Note, however, that RAW has not yet been implemented, and implementation to all terminals is required in order to exhibit effects in the future. Hence, it is expected that it will take time to achieve RAW.

The wireless communication management apparatus 100 according to the embodiment can achieve optimal control that maximizes throughput while minimizing the influence of frame collision in units of base stations according to the actual wireless environment without requiring implementation of a new function.

### 2. Modification

Note that various modifications can be applied to the above-described embodiment.

For example, while the above embodiment describes a case where the terminal 300 and the base station 200 perform wireless communication directly, the present invention is not limited thereto. For example, the terminal 300 and the base station 200 may be configured to wirelessly communicate with each other via a base station (relay base station) that relays wireless communication.

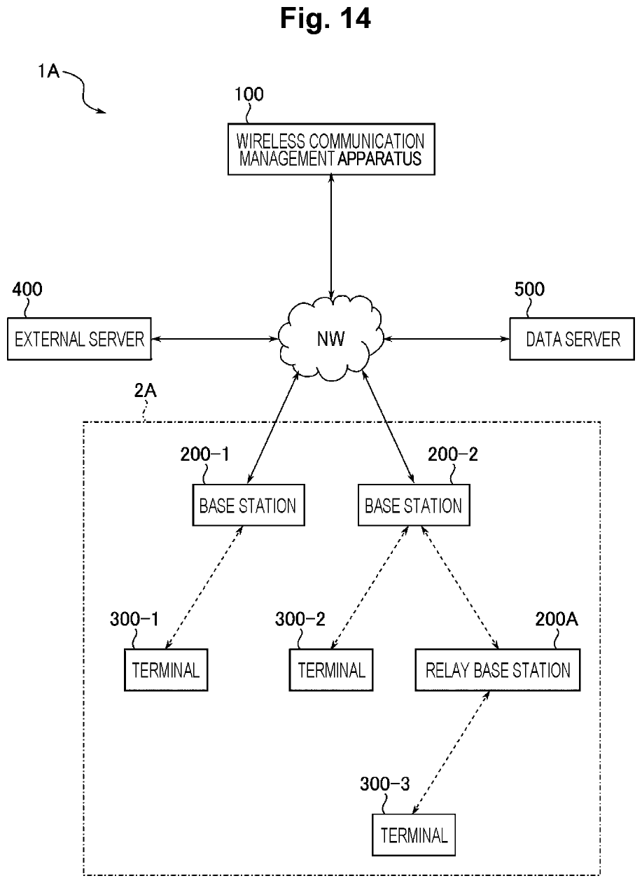

FIG. 14 is a block diagram illustrating an example of a configuration of a communication system according to a modification of the embodiment.

As illustrated in FIG. 14, a communication system 1A includes a wireless communication system 2A.

The wireless communication system 2A includes a plurality of base stations 200-1 and 200-2, a relay base station 200A, and a plurality of terminals 300-1 to 300-3.

The relay base station 200A is configured to wirelessly connect the base station 200 and the terminal 300. The example of FIG. 14 illustrates a case where the relay base station 200A wirelessly connects the base station 200-2 and the terminal 300-3. By forming the wireless communication network via the relay base station 200A in this manner, it is possible to construct the wireless communication system 2A in which the terminals 300 are distributed over a wider range.

The relay base station 200A has, for example, a hardware configuration similar to the hardware configuration of the base station 200 illustrated in FIG. 5. Therefore, the relay base station 200A can also function as the base station 200. Note that in the example of the wireless communication system 2A illustrated in FIG. 14, the relay base station 200A has a function of wirelessly connecting the base station 200 and the terminal 300, and thus does not use the wired communication module 203.

In such a modification, the relay base station 200A can also be counted as the number of connected terminals of the base station 200-2. In the example of FIG. 14, the number of connected terminals of the base station 200-1 is counted as “1”, and the number of connected terminals of the base station 200-2 is counted as “3”. In this case, the “base station 200” refers to a root base station serving as an entrance of an external network. The “relay base station 200A” is not directly connected to an external network.

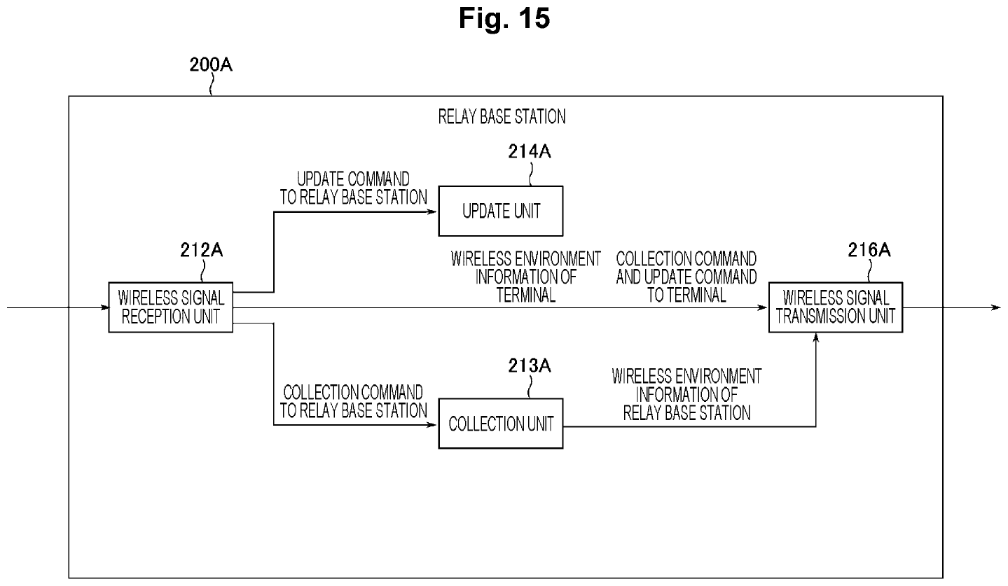

FIG. 15 is a block diagram illustrating an example of a functional configuration of the relay base station according to the modification of the embodiment.

As illustrated in FIG. 15, the relay base station 200A functions as a computer including a wireless signal reception unit 212A, a collection unit 213A, an update unit 214A, and a wireless signal transmission unit 216A.

The wireless signal reception unit 212A receives a collection command and an update command from the base station 200. When receiving a collection command (to relay base station 200A) addressed to the relay base station 200A, the wireless signal reception unit 212A transfers the collection command to the collection unit 213A. When receiving an update command to the relay base station 200A, the wireless signal reception unit 212A transfers the update command to the update unit 214A. When receiving a collection command and an update command (to terminal 300) addressed to the terminal 300, the wireless signal reception unit 212A transmits the collection command and the update command to the wireless signal transmission unit 216A.

In addition, the wireless signal reception unit 212A receives wireless environment information of the terminal 300 from the terminal 300. The wireless signal reception unit 212A transmits the received wireless environment information of the terminal 300 to the wireless signal transmission unit 216A.

The collection unit 213A collects wireless environment information of the relay base station 200A based on the received collection command. The collection unit 213A transmits the collected wireless environment information of the relay base station 200A to the wireless signal transmission unit 216A.

The update unit 214A updates the setting of the wireless environment of the relay base station 200A with control information in the update command based on the received update command. When the update command includes a restart instruction, the update unit 214A restarts the relay base station 200A.

The wireless signal transmission unit 216A transmits the received wireless environment information of the relay base station 200A to the wireless communication management apparatus 100. The wireless signal transmission unit 216A transfers the received wireless environment information of the terminal 300 to the wireless communication management apparatus 100. The wireless signal transmission unit 216A transfers the received collection command and update command of the terminal 300 to the terminal 300.

With the above configuration, the wireless communication management apparatus 100 can collect the wireless environment information of the terminal 300 via the base station 200 and the relay base station 200A. In addition, the wireless communication management apparatus 100 can collect the wireless environment information of the relay base station 200A via the base station 200.

In addition, the wireless communication management apparatus 100 can further consider the wireless environment information of the relay base station 200A. Specifically, for example, the wireless communication management apparatus 100 can compare a propagation path via the relay base station 200A with a propagation path not via the relay base station 200A. As a result, the wireless communication management apparatus 100 can generate an optimum propagation path in the wireless communication system 2A as the control information. Therefore, the wireless environment in the wide-area wireless communication system 2A can be optimized.

### 3. Others

Furthermore, for example, while the above embodiment describes a case where the wireless communication management program is executed by the on-premises wireless communication management apparatus 100, the present invention is not limited thereto. For example, the wireless communication management program may be executed on a calculation resource on the cloud.

Furthermore, for example, while the above embodiment describes a case where the wireless communication management apparatus 100 is connected to the base station 200 via the network NW, the present invention is not limited thereto. For example, the wireless communication management apparatus 100 may be provided in the wireless communication system 2 and function as the root base station 200. In this case, the wireless communication management apparatus 100 may be configured to have both the functional configuration illustrated in FIGS. 7 and 8 and the functional configuration illustrated in FIG. 9.

Furthermore, while the above embodiment describes a case where the wireless communication management apparatus 100 and the data server 500 are physically different servers, the present invention is not limited thereto. That is, the wireless communication management apparatus 100 and the data server 500 may be physically configured in the same server.

Furthermore, the above embodiment describes a case where SSH is used for communication among the wireless communication management apparatus 100, the base station 200, and the terminal 300. However, communication among the wireless communication management apparatus 100, the base station 200, and the terminal 300 is not limited to SSH and any protocol can be used as long as the wireless communication management apparatus 100 can remotely log in to the base station 200 and the terminal 300 and transmit various commands.

Furthermore, for example, while the above embodiment describes a case where the wireless communication management apparatus 100 determines the control value based on the number of connected terminals or the traffic amount as wireless environment information, the present invention is not limited thereto. The wireless communication management apparatus 100 may acquire and use, as wireless environment information, weather, climate, temperature, presence or absence of an obstacle within the coverage, the extent of the coverage, and the like.

Furthermore, for example, while the above embodiment describes a case where the wireless communication management apparatus 100 controls ON/OFF of RTS/CTS by setting the value of RTS_threshold to 1 or 1500, the present invention is not limited thereto. For example, the wireless communication management apparatus 100 may adjust the value of RTS_threshold to a value within a range of [1, 1500] based on the number of connected terminals, the traffic amount, or the like. In this case, when each terminal 300 intends to transmit a frame longer than the designated value of RTS_threshold, the terminal transmits an RTS frame to first obtain a transmission right.

Furthermore, for example, while the above embodiment describes a case where the wireless communication management apparatus 100 determines the value of CWmin using the reference table, the present invention is not limited thereto. For example, the wireless communication management apparatus 100 may use a regression equation for calculating the value of CWmin from the number of connected terminals. Alternatively, the wireless communication management apparatus 100 may determine the value of CWmin in consideration of both the number of connected terminals and the traffic amount. The regression equation for calculating the value of CWmin may be updated as needed.

Furthermore, the wireless communication management apparatus 100 may determine a parameter other than RTS_threshold or CWmin as the control value. For example, the wireless communication management apparatus 100 may determine a parameter (transmission frequency, data compression rate, or the like) for controlling the amount of transmission from the terminal 300.

Alternatively, if the length of the data frame is very short, it is considered that the loss time due to the frame collision illustrated in FIG. 2 is short. Therefore, in a case where the difference between the lengths of the data frame and the RTS frame is equal to or less than a threshold, it may be determined to turn off RTS/CTS.

Note that the present invention is not limited to the foregoing embodiments and various modifications can be made in the implementation stage without departing from the gist of the invention. In addition, each embodiment may be implemented in appropriate combination, and in that case, combined effects can be obtained. Furthermore, the embodiments described above include various inventions, and various inventions can be extracted by a combination selected from a plurality of disclosed components. For example, even if some components are deleted from all the components described in the embodiments, in a case where the problem can be solved and the effects can be obtained, a configuration from which the components are deleted can be extracted as an invention.

### REFERENCE SIGNS LIST

1, 1A Communication system
2, 2A Wireless communication system
100 Wireless communication management apparatus
200-1, 200-2 Base station
200A Relay base station
300-1, 300-2, 300-3 Terminal
400 External server
500 Data server
101, 201, 301 Control circuit
102, 202, 302 Memory
103, 203 Wired communication module
104 User interface
105 Timer
106 Drive
107 Storage medium
204, 303 Wireless communication module
304 Sensor
305 Battery
111 User input unit
112, 211 Wired signal reception unit
113 Control information generation unit
1131 Information acquisition unit
1132 First determination unit
1133 Second determination unit
114 Decision unit
115, 215 Wired signal transmission unit
116 Command library
212, 212A, 311 Wireless signal reception unit
213, 213A, 312 Collection unit
214, 214A, 313 Update unit
216, 216A, 314 Wireless signal transmission unit

1. A wireless communication management apparatus comprising:
an acquisition unit that acquires wireless environment information related to a terminal connected to a base station;
a determination unit that determines a control value that satisfies a throughput for transmitting data from the terminal to the base station based on the wireless environment information; and
a notification unit that notifies the terminal of the control value.

2. The wireless communication management apparatus according to claim 1, wherein
the determination unit determines, as the control value, at least one of a first parameter related to necessity of transmission of a transmission request frame from the terminal to the base station or a second parameter related to calculation of a standby time in the terminal.

3. The wireless communication management apparatus according to claim 2, wherein
the acquisition unit acquires, as the wireless environment information, the number of the terminals or a traffic amount transmitted and received by the terminal, and
the determination unit determines the first parameter so that the terminal transmits the transmission request frame before transmission of the data when the number of terminals or the traffic amount exceeds a threshold, and the terminal does not transmit the transmission request frame before transmission of the data when the number of terminals or the traffic amount is equal to or less than the threshold.

4. The wireless communication management apparatus according to claim 2, wherein
the acquisition unit acquires, as the wireless environment information, the number of the terminals or a traffic amount transmitted and received by the terminal, and
the determination unit determines a size of a contention window according to the number of the terminals or the traffic amount as the second parameter.

5. The wireless communication management apparatus according to any one of claim 1, wherein
the acquisition unit acquires, as the wireless environment information, a sum of the number of terminals directly or indirectly connected to the base station and the number of relay base stations relaying between the terminal and the base station, and
the determination unit determines, based on the sum, a control value that satisfies a throughput for transmitting data from the terminal and the relay base station to the base station.

6. A wireless communication management method executed by a wireless communication management apparatus, the method comprising:
acquiring wireless environment information related to a terminal connected to a base station;
determining a control value that satisfies a throughput for transmitting data from the terminal to the base station based on the wireless environment information; and
notifying the terminal of the control value.

7. A non-transitory computer readable storage medium storing a computer program which is executed by a wireless communication management apparatus to provide the steps of:
acquiring wireless environment information related to a terminal connected to a base station;
determining a control value that satisfies a throughput for transmitting data from the terminal to the base station based on the wireless environment information; and
notifying the terminal of the control value.
